(19) United States
(12) Patent Application Publication
(10) Pub. No.: US 2010/0162341 A1
(43) Pub. Date: Jun. 24, 2010

(54) APPARATUS AND METHOD FOR SUPPORTING EXCESS TRANSPORT STREAMS IN SET-TOP-BOX

(75) Inventor: Hyun-Chul CHOI, Suwon-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/638,237

(22) Filed: Dec. 15, 2009

(30) Foreign Application Priority Data
Dec. 18, 2008 (KR) 10-2008-0129316

(51) Int. Cl. H04N 7/173

(52) U.S. Cl. 725/131

(57) ABSTRACT

An apparatus and a method for processing excess transport streams in a broadcast receiver are provided. The apparatus for processing the excess transport streams in the broadcast receiver includes a controller for determining whether a number of received transport streams exceeds a maximum number of transport streams, a memory for, when the number of the received transport streams exceeds the maximum number of the transport streams, storing one or more excess transport streams, and a cablecard for descrambling and processing the stored one or more excess transport streams when the cablecard has spare capacity. Thereby, there is no need to install an additional cablecard to process the one or more excess transport streams.

### PRIORITY

This application claims the benefit under 35 U.S.C. §119(a) of a Korean patent application filed in the Korean Intellectual Property Office on Dec. 18, 2008 and assigned Serial No. 10-2008-0129316, the entire disclosure of which is hereby incorporated by reference.

### BACKGROUND OF THE INVENTION

1. Field of the Invention

The present invention relates to a Set-Top Box (STB). More particularly, the present invention relates to an apparatus and a method for supporting excess transport streams in the STB which employs a cablecard supporting multi-stream.

2. Description of the Related Art

A Set-Top Box (STB) is a device connected to a home TV for receiving cable or satellite broadcasts. The STB has a function which amplifies a video signal received via an antenna, removes noise, and produces a corresponding video signal on the TV in accordance with a desired channel of a user.

With regard to digital content distribution, it is easy to not only copy but also edit and distribute the digital content. In this respect, access and protection of the content is required. A Copy Protection System (CPS) for the digital broadcast content and a Conditional Access System (CAS) technique are introduced. When an embedded CAS is hacked, there is no way to protect providers against the hacking. Yet, even in such a situation, when a CableCard is included, the providers can be protected from the hacking merely by changing the CableCard without incurring considerable cost or inconvenience. For this reason, CableLabs™ defines an OpenCable™ standard as the next-generation digital cable broadcasting standard.

In relation to a digital cable broadcast receiver, the CableLabs™ standard separates the cablecard (referred to as a conditional access module) from the receiver and defines its relevant interface. The cablecard interface includes an S-Mode for processing only a single channel and an M-Mode for processing multiple channels.

Herein, after the cablecard is coupled to a host (e.g., STB) and a host control session is established, the cablecard informs the host of its multi-stream capabilities. When doing so, the cablecard informs the host of a maximum number of transport streams supported through a stream_profile Application Protocol Data Unit (APDU), how many programs are communicated over a program_profile APDU, and how many elementary streams are communicated over an es_profile APDU. The APDU is a data unit communicated between peer application entities in the application layer and includes application protocol control information and application layer user data.

As stated above, the cablecard of the related art informs the host of the MPEG Transport Streams (TSs) concurrently supportable by the cablecard through the stream_profile APDU and thus supports the available Moving Picture Experts Group (MPEG) TSs.

In most cases, when 256 Quadrature Amplitude Modulation (QAM) is used within a frequency, 6 Standard Definition (SD) channels can operate, 1 High Definition (HD) channel can operate, or tens of music channels can operate. Given a BandWidth (BW) of 6 MHz and 38 Mbps of the 256QAM, it is typically assumed that each SD channel is 6 Mbps, each HD channel is 19 Mbps, and each music channel is 500 kbps.

The maximum number of streams (max_number_of_streams) of the cablecard of the M-Mode is 5 or 6 at maximum, and the number of the TSs concurrently supportable is 5 or 6 at maximum.

However, to support more TSs than the maximum number of the TSs, the user has to install an additional cablecard, which incurs additional cost to the user.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for processing excess transport streams in a Set-Top Box (STB).

Another aspect of the present invention is to provide an apparatus and a method for processing excess transport streams stored after an STB stores excess transport streams unable to be processed earlier by a cablecard.

Yet another aspect of the present invention is to provide an apparatus and a method for processing a transport stream without an additional cablecard with respect to excess transport streams in an STB.

In accordance with an aspect of the present invention, an apparatus for processing excess transport streams in a broadcast receiver is provided. The apparatus includes a controller for determining whether a number of received transport streams exceeds a maximum number of transport streams, a memory for, when the number of the received transport streams exceeds the maximum number of the transport streams, storing one or more excess transport streams, and a cablecard for descrambling and processing the stored one or more excess transport streams when the cablecard has spare capacity.

In accordance with another aspect of the present invention, a method for processing excess transport streams in a broadcast receiver is provided. The method includes determining whether a number of received transport streams exceeds a maximum number of transport streams, when the number of the received transport streams exceeds the preset maximum number of the transport streams, storing one or more excess transport streams, and descrambling and processing the stored excess transport streams when there is spare capacity to descramble and process the stored one or more excess transport streams.

In accordance with yet another aspect of the present invention, an apparatus for processing excess transport streams in a broadcast receiver is provided. The apparatus includes a controller for, when a number of received transport streams exceeds a maximum number of transport streams, generating a Program Map Table (PMT) for one or more excess transport streams, a memory for storing the one or more excess transport streams and the PMT, and a cablecard for descrambling and processing the stored one or more excess transport streams and the PMT when the cablecard has spare capacity.

In accordance with still another aspect of the present invention, a method for processing excess transport streams in a broadcast receiver is provided. The method includes when a number of received transport streams exceeds a maximum number of transport streams, generating a PMT for one or more excess transport streams, storing the excess transport streams and the PMT, and descrambling and processing the stored one or more excess transport streams and the PMT when there is spare capacity to descramble and process the stored one or more excess transport streams.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments the present invention will become more apparent from the following description taken in conjunction with the accompanying drawings, in which:

FIG. 1 is a block diagram of a Set-Top Box (STB) for processing excess transport streams according to an exemplary embodiment of the present invention; and

FIG. 2 is a flowchart of operations of an STB for processing excess transport streams according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention provide an apparatus and a method for processing excess transport streams in a Set-Top Box (STB).

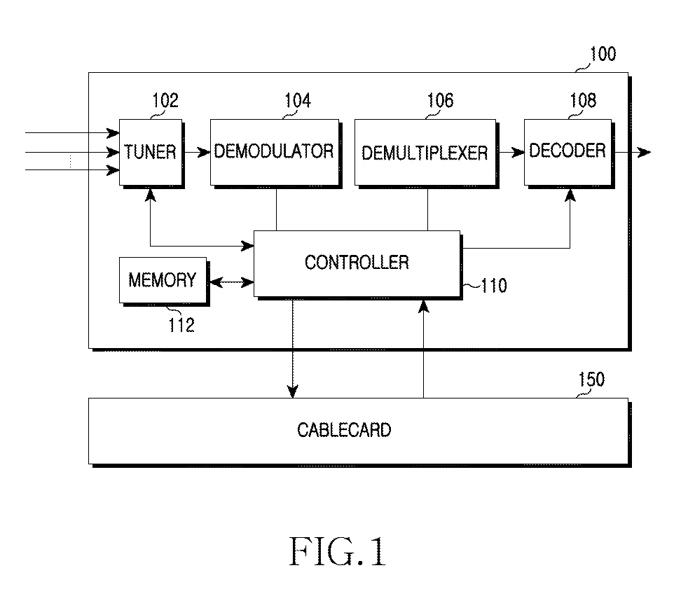

FIG. 1 illustrates a block diagram of the STB for processing excess transport streams according to an exemplary embodiment of the present invention.

Referring to FIG. 1, the STB 100 includes a tuner 102, a demodulator 104, a demultiplexer 106, a decoder 108, a controller 110, a memory 112, and a cablecard 150. Herein, the cablecard 150 conforms to a defined interface standard and is coupled to the STB 150 to provide paid broadcasting services. When coupled to the STB 150, the cablecard 150 may be installed in the STB 150.

A broadcasting system (or a broadcasting station) transmits one or more of audio, video and data over one channel. The transmitted broadcast signal may be scrambled by a Control Word (CW) to restrict viewing of the broadcast programs.

The tuner 102 tunes to an intended broadcast signal and outputs the tuned broadcast signal to the demodulator 104 under the control of the controller 110. When a desired broadcast channel is selected through a user interface (remote controller, selection button, etc.), the controller 110 reads information corresponding to the selected broadcast channel from the memory 112 and provides the channel information to the tuner 102.

The demodulator 104 demodulates the tuned broadcast signal into a digital bit stream. The bit stream includes one or more of video, audio, data stream, and control information (e.g., CW). The one or more of video, audio, data stream, and CW are output to the controller 110.

The controller 110 controls the STB. In this exemplary embodiment, the controller 110 determines whether the number of the transport streams received at the tuner 102 exceeds a maximum number of the transport streams, and temporarily stores any excess transport streams in the memory 112 according to the result. The memory 112 may be any type of memory including a hard disc.

For example, when the number of the received transport streams is smaller than or equal to the maximum number of the transport streams, the controller 110 sends all of the received transport streams to the cablecard 150 and sends a first Conditional Access_Program Map Table (CA_PMT) based on the received transport streams to the cablecard 150 through a separate control interface. The first CA_PMT includes one or more of an Entitlement Control Message (ECM), an audio Packet IDentifier (PID), a video PID, a Program Clock Reference (PCR) PID, and so on. The cablecard 150 descrambles the one or more of the ECM, the audio PID, the video PID, and the PCR PID of the first CA_PMT and sends them to the controller 110.

When the number of received transport streams is greater than the maximum number of the transport streams, the controller 110 stores any excess transport streams in the memory 112 and sends the maximum number of transport streams to the cablecard 150.

The controller 110 determines whether there is spare cablecard capacity. When detecting that there is spare cablecard capacity, the controller 110 reads the additional transport streams stored in the memory 112, generates a second CA_PMT based on the information of the additional transport streams, and sends the second CA_PMT to the cablecard 150 together with the additional transport streams.

The cablecard 150 determines whether the broadcast signal demodulated from the controller 110 is an unscrambled signal, a Conditional Access System (CAS) signal, or a Copy Protection (CP) signal, and provides the received broadcast signal to the controller 110.

For example, when the broadcast signal is not scrambled, the cablecard 150 forwards the received broadcast signal to the controller 110 as it is. When the broadcast signal is the CAS signal, the cablecard 150 descrambles the received broadcast signal and outputs the descrambled broadcast signal to the controller 110. When the broadcast signal is the CP signal, the cablecard 150 receives a CP key and the scrambled broadcast signal from the controller 110, encrypts the CP key, and descrambles the scrambled broadcast signal (including one or more of audio, video, and data signals) with the encrypted CP key. The cablecard 150 re-scrambles the descrambled broadcast signal and outputs the re-scrambled broadcast signal to the controller 110.

The demultiplexer 116 splits the one or more of the audio, video, and data signals from the descrambled broadcast signal and provides them to the decoder 108. The decoder 108 decodes the one or more of the video, audio, and data streams.

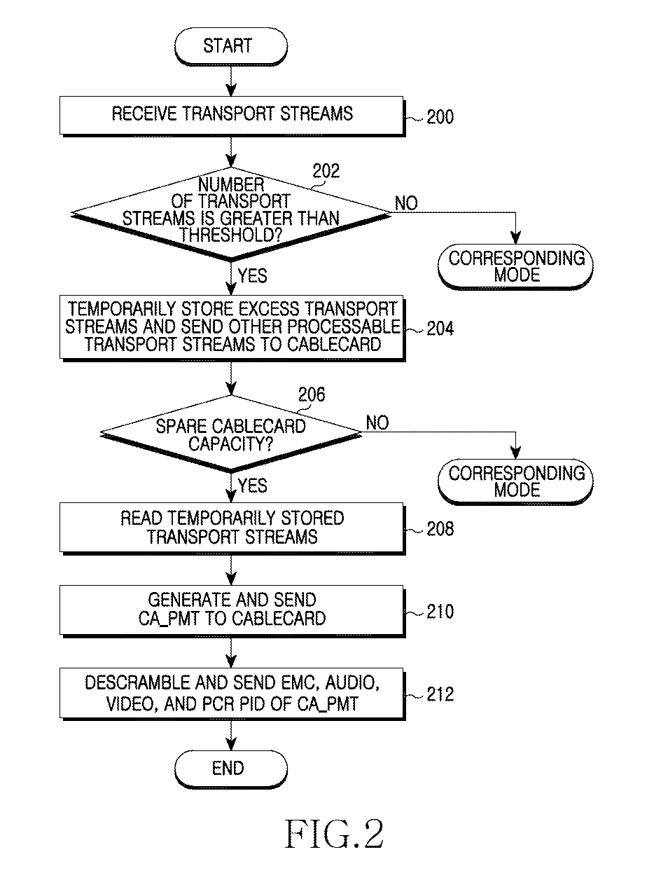

FIG. 2 illustrates a flowchart of operations of an STB for processing excess transport streams according to an exemplary embodiment of the present invention.

Referring to FIG. 2, the tuner 102 receives the plurality of the transport streams in step 200, and the controller 110 compares the number of the received transport streams with a threshold in step 202.

If it is determined in step 202 that the number of the received transport streams is smaller than or equal to the threshold, the STB performs the corresponding mode operation. In the corresponding mode operation, the controller 110 sends all of the received transport streams to the cablecard 150 and sends the first CA_PMT based on the received transport streams to the cablecard 150 through the separate control interface. The first CA_PMT includes one or more of the ECM, the audio PID, the video PID, and the PCR PID. The cablecard 150 descrambles the one or more of the ECM, the audio PID, the video PID, and the PCR PID of the first CA_PMT and sends them to the controller 110.

On the other hand, if it is determined in step 202 that the number of the received transport streams is greater than the threshold, the controller 110 stores any excess transport streams in the memory 112 and sends other processable transport streams to the cablecard 150 in step 204. For example, when the maximum number of processable transport streams of the cablecard 150 is ‘5’ and the number of the received transport streams is ‘7’, the controller 110 selects and sends only ‘5’ transport streams to the cablecard 150 and temporarily stores the other ‘2’ transport streams in the memory 112. At this time, the second CA_PMT of the stored transport stream is stored together. Alternatively, the controller 110 may generate the second CA_PMT based on the stored transport streams.

Next, the controller 110 determines whether there is spare cablecard capacity in step 206. If it is determined in step 206 that there isn't any spare cablecard capacity, the STB performs a corresponding mode operation. However, if it is determined in step 206 that there is spare cablecard capacity (i.e., after processing the permissible transport streams), the controller 110 reads the additional transport streams and the second CA_PMT stored in the memory 112 in step 208.

In step 210, the controller 110 generates the second CA_PMT (or reads the stored second CA_PMT) based on the information of the additional transport streams and sends the second CA_PMT to the cablecard 150 together with the additional transport streams. The additional transport streams are output to the cablecard 150 through a data interface and the second CA_PMT is output to the cablecard 150 through the separate control interface.

In step 212, the cablecard 150 descrambles one or more of the ECM, the audio PID, the video PID, and the PCR PID of the second CA_PMT and sends them to the controller 110 together with the additional transport streams.

Next, the STB finishes this process.

Although not illustrated in FIGS. 1 and 2, when sending the excess transport streams to the cablecard 150, if necessary, the controller 110 may inform that the corresponding transport streams are excess transport streams and the cablecard 150 may inform the controller 110 of the spare capacity for processing the excess transport streams. In addition, while a plurality of excess transport streams has been described above, there may only be one excess transport stream. Also, while a Conditional Access_Program Map Table (CA_PMT) has been described above, a Program Map Table (PMT) may be implemented.

As set forth above, by temporarily storing the excess transport streams and processing the stored excess transport streams at a processable time in the STB, there is no need to install an additional cablecard. Therefore, a cost to process excess transport streams is avoided.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for processing excess transport streams in a broadcast receiver, the apparatus comprising:
a controller for determining whether a number of received transport streams exceeds a maximum number of transport streams;
a memory for storing one or more excess transport streams when the number of the received transport streams exceeds the maximum number of the transport streams; and
a cablecard for descrambling and processing the one or more stored excess transport streams when the cablecard has spare capacity.

2. The apparatus of claim 1, wherein the controller reads the stored one or more excess transport streams from the memory.

3. The apparatus of claim 1, wherein the controller sends the one or more excess transport streams to the cablecard and sends a Conditional Access_Program Map Table (CA_PMT) based on the one or more excess transport streams.

4. The apparatus of claim 3, wherein the CA_PMT is stored in the memory with the one or more excess transport streams.

5. The apparatus of claim 3, wherein, when sending the one or more excess transport streams to the cablecard, the controller informs that the one or more transport streams being sent are one or more excess transport streams.

6. The apparatus of claim 1, wherein the cablecard informs the controller of whether there is spare capacity for processing the one or more excess transport streams.

7. A method for processing excess transport streams in a broadcast receiver, the method comprising:
determining whether a number of received transport streams exceeds a maximum number of transport streams;
storing one or more excess transport streams when the number of the received transport streams exceeds the maximum number of the transport streams; and
descrambling and processing the one or more stored excess transport streams when there is spare capacity to descramble and process the stored one or more excess transport streams.

8. The method of claim 7, further comprising:
reading the stored one or more excess transport streams.

9. The method of claim 7, further comprising:
sending the one or more excess transport streams to a cablecard and sending a Conditional Access_Program Map Table (CA_PMT) based on the one or more excess transport streams.

10. The method of claim 9, wherein the CA_PMT is stored in the memory with the one or more excess transport streams.

11. The method of claim 9, further comprising:
when sending the one or more excess transport streams to the cablecard, informing that the one or more transport streams being sent are one or more excess transport streams.

12. The method of claim 7, further comprising:
informing of whether there is spare capacity for descrambling and processing the one or more excess transport streams.

13. An apparatus for processing excess transport streams in a broadcast receiver, the apparatus comprising:
a controller for, when a number of received transport streams exceeds a maximum number of transport streams, generating a Program Map Table (PMT) for one or more excess transport streams;
a memory for storing the one or more excess transport streams and the PMT; and
a cablecard for descrambling and processing the stored one or more excess transport streams and the PMT when the cablecard has spare capacity.

14. The apparatus of claim 13, wherein the PMT includes one or more of an Entitlement Control Message (ECM), an audio Packet IDentifier (PID), a video PID, and a Program Clock Reference (PCR) PID.

15. The apparatus of claim 13, wherein the PMT comprises a Conditional Access_PMT (CA_PMT).

16. The apparatus of claim 13, wherein the PMT is generated and stored after the one or more excess transport streams are stored.

17. A method for processing excess transport streams in a broadcast receiver, the method comprising:
generating a Program Map Table (PMT) for one or more excess transport streams when a number of received transport streams exceeds a maximum number of transport streams;
storing the one or more excess transport streams and the PMT; and
descrambling and processing the stored one or more excess transport streams and the PMT when there is spare capacity to descramble and process the stored one or more excess transport streams.

18. The method of claim 17, wherein the PMT includes one or more of an Entitlement Control Message (ECM), an audio Packet IDentifier (PID), a video PID, and a Program Clock Reference (PCR) PID.

19. The method of claim 17, wherein the PMT comprises a Conditional Access_PMT (CA_PMT).

20. The method of claim 17, wherein the PMT is generated and stored after the one or more excess transport streams are stored.
